(19) United States
(12) Patent Application Publication
(10) Pub. No.: US 2009/0177315 A1
(43) Pub. Date: Jul. 9, 2009

(54) Product, Dispenser and Method of Dispensing Product

(75) Inventors: Harold J. Goeking, Oshkosh, WI (US); William D. Sleeper, Roswell, GA (US); Dale T. Gracyalny, Alpharetta, GA (US); Alison B. Lukacsko, Duluth, GA (US); Gary N. Petersen, Neenah, WI (US); Daniel J. Geddes, Appleton, WI (US); Kathleen A. Jordan, Alpharetta, GA (US); Abby C. Case, Green Bay, WI (US); Antonio M. Cittadino, Appleton, WI (US); Bret A. Kuehneman, Neenah, WI (US); Christopher M. Reinsel, Neenah, WI (US); Panagiotis Zosimadis, Brampton (CA); Alexandre Izmailov, Toronto (CA)

Correspondence Address: PATENT GROUP GA030-43;Georgia-Pacific LLC, 133 PEACHTREE STREET, N.E., ATLANTA, GA, 30303-1847, US

(73) Assignee: Georgia-Pacific Consumer Products LP, Atlanta, GA (US)

(21) Appl. No.: 12/339,888

(22) Filed: Dec. 19, 2008

Related U.S. Application Data
(60) Provisional application No. 61/015,691, filed on Dec. 21, 2007.

(51) Int. Cl. G06F 17/00; B65H 75/18; A47K 10/24

(52) U.S. Cl. 700/231; 242/600; 221/45

(57) ABSTRACT

A method of dispensing product includes determining by a processor if product loaded into a dispenser is authorized for use in the dispenser by identifying a reference indication associated with the product; in response to determination that the product is authorized, dispense a first amount of product; and in response to determination that the sheet product is unauthorized, dispense a second amount of sheet product, wherein the second amount of sheet product is different than the first amount.

### CROSS-REFERENCE TO RELATED APPLICATION

This application claims priority to U.S. Provisional Application No. 61/015,691 filed Dec. 21, 2007, which is herein incorporated by reference in its entirety.

### BACKGROUND OF THE INVENTION

The present disclosure relates generally to dispensers, and more specifically to dispensers that discourage the use of unauthorized product.

Dispenser apparatus for dispensing flexible sheet product, such as paper towel and the like, are well known in the art. Such dispensers typically discharge sheet product provided in the form of a sheet product roll. The sheet product roll comprises a sheet product web wound about a core. The core is typically in the form of a cylindrically-shaped hollow core made of paper, plastic or a like material. The core typically has an inner surface and open ends provided to mount the sheet product roll within the dispenser. The sheet product roll may be mounted within the dispenser, for example, by means of a yoke with roll holders or mandrels adapted for insertion into the open ends of the core.

Dispensers presently commercially generally available lack any capability to identify whether a product is authorized for use with such dispensers. The use of unauthorized sheet product in a proprietary dispenser can contribute to unreliable operation of the dispenser. The practice of supplying unauthorized paper to a proprietary dispenser is sometimes referred to in the art as “stuffing”. One proposed method of addressing this problem of unauthorized sheet product use in a dispenser has been to provide a dispenser permitting recognition of sheet product for use with a given dispenser and “locking-out” (e.g., disabling) the dispenser when unauthorized sheet product is employed. One problem of “lock-out” schemes is that they disable the dispenser, thereby giving the appearance of unreliability of the dispenser to the end user.

Accordingly, a continual need exists for dispensers that discourage the use of unauthorized product.

### BRIEF DESCRIPTION OF THE INVENTION

Disclosed herein are products, dispensers and methods of dispensing products.

In one embodiment, a method of dispensing product, the method comprises determining by a processor if product loaded into a dispenser is authorized for use in the dispenser by identifying a reference indication associated with the product; in response to determination that the product is authorized, dispense a first amount of product; and in response to determination that the sheet product is unauthorized, dispense a second amount of sheet product, wherein the second amount of sheet product is different than the first amount.

In one embodiment, a method of dispensing product, the method comprises determining by a processor if product loaded into a dispenser is authorized for use in the dispenser by identifying a reference indication associated with the product; in response to determination that the product is authorized, dispense the product at a first speed; and in response to determination that the sheet product is unauthorized dispense a the product at a second speed, wherein the second speed is different than the first speed.

In one embodiment, a sheet product comprises a core; and a sheet product web wound about the core, wherein the core comprises an overt indication that is visible to the human eye and/or a covert indication that is not visible to the human eye.

In one embodiment, a sheet product dispenser for dispensing sheet product from a roll, the sheet product dispenser comprises a processor responsive to executable instructions; a support for rotatably supporting the roll; a sensor in signal communication with the processor and responsive to rotation of the roll to detect a reference indication on a core of the roll, wherein the reference indication being associated with authorized use of the sheet product in the dispenser; and a feed mechanism comprising a drive motor responsive to the processor for advancing the sheet product out of the sheet product dispenser; wherein the processor, upon execution of the instructions, implements a method, the method comprising: determining if the roll loaded into the sheet dispenser comprises the reference indication; in response to determination that the sheet product has the reference indication dispense a first length of sheet product; and in response to determination that the sheet product is absent the reference indication dispense a second length of sheet product, wherein the second length of sheet product is greater than the first length.

In one embodiment, a sheet product dispenser for dispensing sheet product from a roll, the sheet product dispenser comprises a processor responsive to executable instructions; a support for rotatably supporting the roll; a sensor in signal communication with the processor and responsive to rotation of the roll to detect a reference indication on a core of the roll, wherein the reference indication being associated with authorized use of the sheet product in the dispenser; and a feed mechanism comprising a drive motor responsive to the processor for advancing the sheet product out of the sheet product dispenser; wherein the processor, upon execution of the instructions, implements a method, the method comprising: determining if the roll loaded into the sheet dispenser comprises the reference indication; in response to determination that the sheet product has the reference indication dispense sheet product at a first speed; and in response to determination that the sheet product is absent the reference indication dispense sheet product at a second speed, wherein the second speed is different than the first speed.

These and other advantages and features will be more readily understood from the following detailed description of preferred embodiments of the invention that is provided in connection with the accompanying drawings.

### BRIEF DESCRIPTION OF THE DRAWINGS

Referring to the exemplary drawings wherein like elements are numbered alike in the accompanying Figures:

FIG. 1 is a perspective view of a sheet product dispenser in accordance with an embodiment of the invention;

FIG. 2 is a rear side perspective view of a chassis assembly and parts shown in FIG. 1 in accordance with an embodiment of the invention;

FIG. 3 is a block diagram of an electrical control system that may be implemented in the dispenser of FIG. 1 in accordance with an embodiment of the invention;

FIG. 4 is a perspective view of a roll of sheet product in accordance with an embodiment of the invention;

FIG. 5 is a cross section view of a detector in conjunction with the roll of sheet product of FIG. 4 in accordance with an embodiment of the invention; and

FIG. 6 is a flowchart of process steps for a method of dispensing a length of sheet product in accordance with an embodiment of the invention.

### DETAILED DESCRIPTION OF THE INVENTION

Disclosed herein are dispensers that that discourage the use of unauthorized products (articles). For ease in discussion, reference is made to the product being a sheet product, with the understanding that a person of skill in the art can readily adapt these teachings to other articles, such as flowable products (e.g., liquids, foams, gases, or gels), cutlery, cups, and the like without undue experimentation.

As used herein, the terms “sheet product” and “sheet products” are inclusive of natural and/or synthetic cloth or paper sheets. Further, sheet products can include both woven and non-woven articles. Examples of sheet products include, but are not limited to wipers, napkins, tissues, and towels.

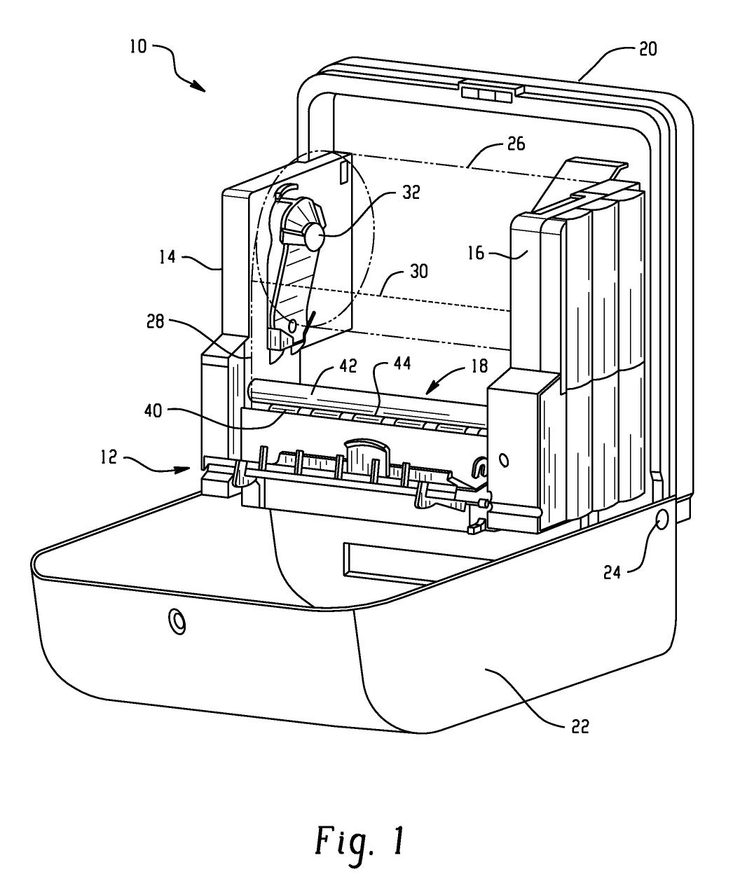

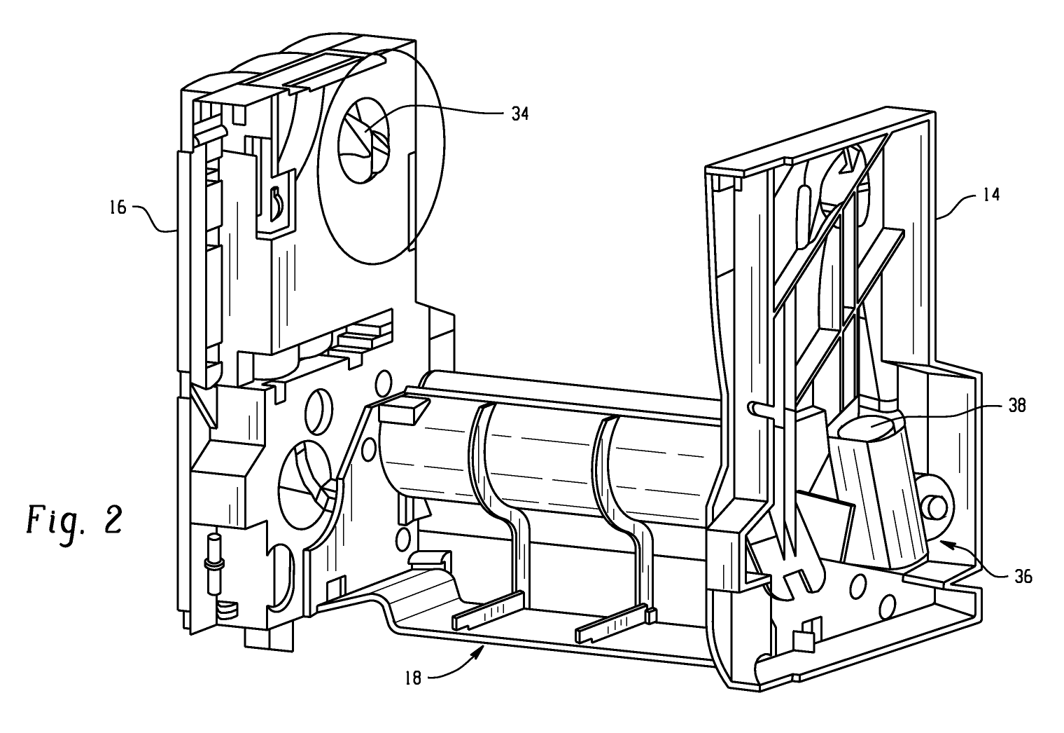

Referring to FIGS. 1 and 2, an embodiment of a sheet dispenser 10 adapted to dispense sheet products is depicted. The sheet dispenser 10 includes a chassis assembly 12 that includes a right side chassis member 14, a left side chassis member 16, and a middle chassis member 18 extending between the side chassis members 14, 16. Dispenser 10 further includes a back panel member 20 and a pivotal front cover 22 attached, by a pin 24, hinge or other convenient attachment mechanism, to back panel member 20. Front cover 22 may be opened and pivoted away from chassis assembly 12 to a web loading position (as shown) allowing a roll 26 of sheet product 28 to be loaded into dispenser 10. Roll 26 is rotatably supported between a pair of supports, such as inwardly directed hubs 32, 34 that can be loosely received within the core of the roll 26 to permit free rotation of the roll 26. Of course, numerous other roll mounting arrangements could also be used.

Middle chassis member 18 provides a foundation for a feed mechanism 36, driven by an electric motor 38, serving to dispense web 28 from roll 26 in incremental sheet segments. In one embodiment as depicted, the feed mechanism includes a mating feed (drive) roller 40 and pressure roller 42 which cooperate to dispense the web material 28. Feed roller 40 and pressure roller 42 are mounted upon axles rotatably supported at their ends by side chassis members 14, 16. Pressure roller 42 may be biased against feed roller 40 by a spring (not shown) to define a feed nip 44. When web 28 is fed into nip 44, rotation of feed roller 40 causes web 28 to be advanced through nip 44, around feed roller 40.

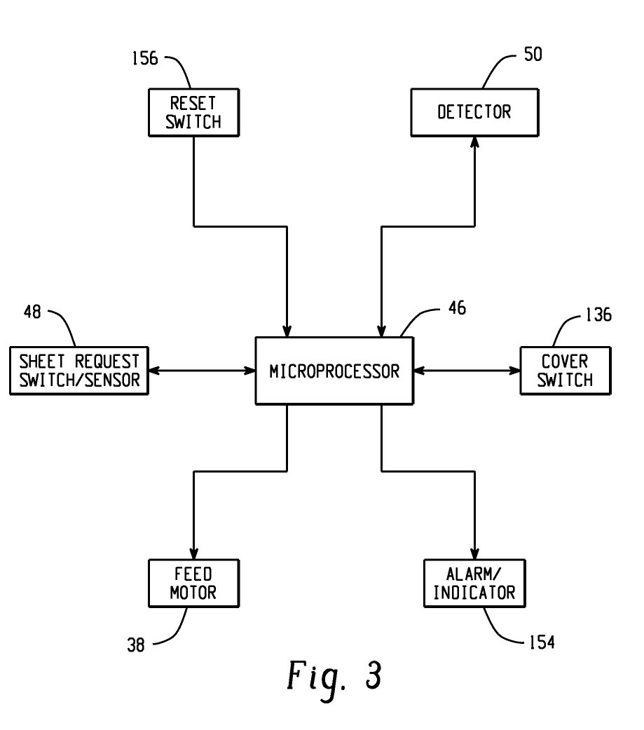

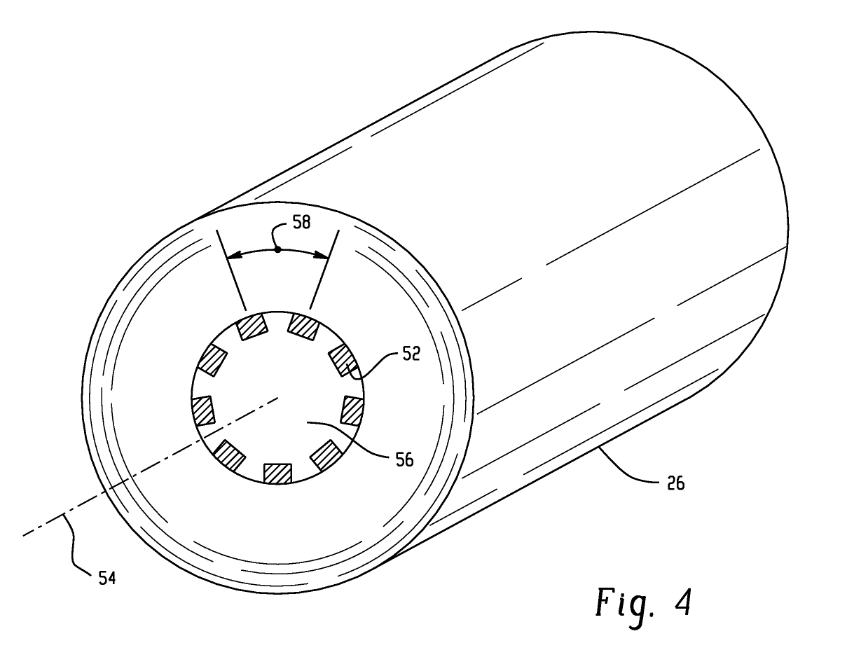

FIG. 3 (with periodic reference to FIG. 1) depicts various electrical components of dispenser 10, and their interrelationship with each other. A microprocessor 46 controls dispenser 10 to feed a sheet segment in response to receipt of a signal from a sheet request switch or sensor 48. A detector 50 in signal communication with the microprocessor 46 controls the amount, or length of web 28 fed per dispense cycle by controlling feed motor 38. Detector 50 may be a shaft encoder, either electromechanical or optical, mounted to generate a pulse for each small increment of rotation of feed roller 40. In one embodiment, an optical shaft encoder can be mounted on an axle of feed roller 40 to output a pulse train corresponding to rotation of the feed roller 40. With reference back to FIG. 3, in addition to receiving input signals from the sheet requests sensor/switch 48, detector (encoder) 50, and cover switch 136, microprocessor 46 may also optionally receive input from a manual reset button 156 effectively serving to return the state of the microprocessor 46 to the initial state assumed upon closure of cover 22. In one embodiment, the microprocessor 46 may be responsive to loading of such material absent reference indications 52 (FIG. 4) to indicate use of unidentified material by flashing a light-emitting-diode (LED).

In the illustrated embodiment, roll 26 includes a continuous web 28 of flat segments of sheet product that may be wound upon a hollow cylindrical core. Dispenser 10 could, of course, dispense other flexible webs 28. The web 28 could, for example, be in the form of folded sheet segments wound onto a roll and separable from each other along lines of perforation to form folded napkins. In one embodiment, the roll 26 includes reference indications 52 (FIG. 4) associated with the sheet product to identify the sheet product as being an “authorized” product for use in the dispenser 10. For example, the reference indications 52 can be disposed on a core of the roll 26 or disposed on the web 28. The term “authorized” is being used to denote that the product or article is sanctioned for use in the dispenser. For example, the authorized product may refer to branded product that is used in a proprietary dispenser; it may refer to permissions give to distributors for given dispensers in a geographical region or channel; and the like.

The reference indications 52 may be visible or invisible to the human eye, but are detectable via a sensor. The sensor employed will vary depending on the choice of reference indications 52. For example, suitable reference indications include, but are not limited, to bar codes; RFID “radio frequency identification” tags; inks or dyes; conductive particles, fibers, or metals; tick marks; ridges.

In on embodiment, the reference indications may include one or more marks that fluoresce when in the presence of light provided from a light source. The lights source, detector, and reference indications can all correspond with each other such that these components operate with light of a predetermined wavelength. However, while fluorescence marks may be suitable for many occasions, a sophisticated counterfeiter or stuffer may find these fluorescence marks provide a low hurdle to overcome. It has been discovered that the use of phosphoresce inks can provide a higher hurdle for counterfeiting and may be preferred for some embodiments.

In one embodiment, the roll comprises an overt indication that is visible to the human eye that can act as a decoy to potential counterfeiters and a covert indication that is not visible by the human eye. A supplier of the product may vary the overt indication for different production runs to keep the potential counterfeiter guessing as to the purpose of the indication, while the covert indication is the indication actually used to determine whether or not a product is authorized or unauthorized.

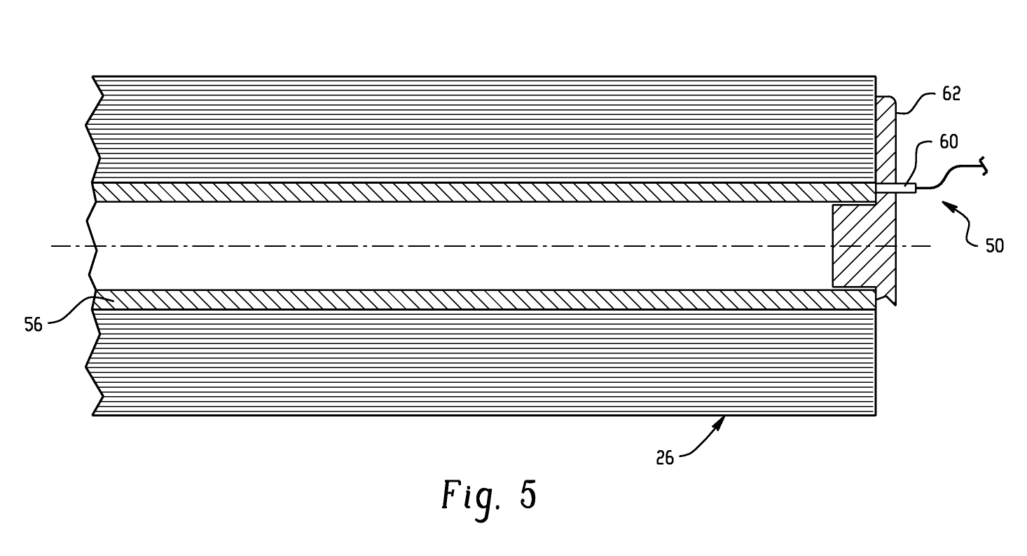

FIGS. 4 and 5 depict an embodiment in which the detector 50 may include use of a plurality of reference indications 52 (also herein referred to as “markers”) disposed upon the roll 26 of sheet product proximate a center axis 54 of the roll 26 printed upon a core 56 of the roll 26, for example. In one embodiment, the reference indications 52 are spaced at a regular interval 58, such as from center to center, or leading edge to leading edge, for example. However, other embodiments are envisioned where the reference indications 52 are spaced at irregular intervals (e.g., bar codes). The detector 50 includes a sensor 60. The type of sensor employed as sensor 60 varies depending on the reference indication 52 employed. Suitable sensors include, but are not limited to, an optical reflectivity sensor (e.g., a linear optical array) adapted to detect the presence of a reflective object or code associated with the roll 26, a magnetic sensor adapted to detect the presence of magnetic ink or other magnetic object associated with the roll 26, a RFID tag sensor adapted to detect and RFID tag associated with the roll 26, a capacitive field disturbance/proximity detector, and an electrical contact sensor to detect the present of a conductive element associated with the roll 26. The sensor 60 is in signal communication with the processor 46 via the detector 50 and is disposed upon a structure 62 proximate the core 56, such as roll supports defined in conjunction with hubs 32, 34 as described above and shown in reference to FIGS. 1 and 2.

FIG. 5 depicts an exemplary mounting arrangement of the sensor 60. The sensor 60 can be utilized in conjunction with the reference indications 52 (best seen with reference to FIG. 4) to sense the presence or absence of the reference indicators 52. The sensor 60 is mounted to the structure 62, which remains stationary relative to the roll 26 as it rotates about the center axis 54. As the roll 26 rotates about its center 54, the reference indications 52 are alternatively disposed in front of the sensor 60. Therefore, rotation of the roll 26 results in a pulse train that can be detected by the detector 50 and corresponds to rotation of the reference indications 52 past the sensor 60. Further, in one embodiment, the sensor 60 is responsive to removal of the roll 26 to sense an increase in ambient light and recognize the removal of the roll 26.

Referring now to FIG. 6 (with periodic reference to FIG. 1-5), which is a logical flow diagram of a method 300 of dispensing products from a dispenser will now be described. The method 300 may be followed out as shown in FIG. 3 and the method may include additional or fewer actions than those shown in FIG. 3. Thus, it should be apparent to those ordinarily skilled in the art that the method 300 can be modified depending on a desired application to yield additional methods within the scope of the present invention.

As shown, the method 300 comprises a product check 310. In one embodiment, the product is a sheet product (e.g., continuous web 28), which has been encoded with certain product identification information. The dispenser 10 is configured to obtain product identification information by one or more sensing/detection methods. For example, in some embodiments a light source and a photo detector may be used to obtain product identification information. The light source and the photo detector can be placed within the dispenser in such a location as to obtain product identification information placed at one or more predetermined locations on the product. In such a configuration, the light source can direct light at a predetermined wavelength toward the product. The product can be configured to include a dye mark that will reflect back light provided by the light source. The photo detector can be configured to receive light reflected back by the dye mark.

The method 300 can also include continuous checking of product during dispensing operations. Such testing can be performed at predetermined intervals by microprocessor 46. In addition, such testing may be performed in response to end user activity receiving product from the dispenser. This enables a process to continuously monitor product for dispensing and end user interaction with a dispenser.

If it is determined at product check 310 that authorized product is being employed in the dispenser 10, the dispenser 10 will dispense product per an authorized product schedule at 320. For example, the authorized product schedule can be the amount of product the dispenser is normally set to dispense. If, however, it is determined that unauthorized product is being employed in the dispenser 10, the dispenser 10 will dispense product per an un-authorized product schedule 330. For example, the un-authorized product schedule can dispense product in a manner to discourage stuffing the dispenser with counterfeit product.

One driver for a customer to purchase counterfeit product is price, i.e., a counterfeit product (unauthorized product) is likely to cost less money than an original product (authorized product). In one embodiment, the dispenser discourages stuffing by destroying the cost-in-use proposition for a competitor attempting to “stuff” a propriety dispenser with unauthorized sheet products. In other words, a facility operator employing unauthorized product actually ends up spending more money than he would have spent using the authorized product, because an excessive amount of sheet product is dispensed when an unauthorized sheet product is employed.

In one embodiment, the dispenser 10 “over delivers” product, if an un-authorized product is employed in the dispenser. As used herein, the term “over delivery” refers to a pre-determined amount of extra product dispensed compared to a normal dispense cycle if authorized product had been employed. For example, if the dispenser where programmed to dispenser “X” amount of authorized product, the dispenser can dispenser X plus a set amount extra, two times X, three times X, or a greater amount, if un-authorized product is employed. The amount can be selected such that the un-authorized product will cost the facility operator more money to dispense un-authorized product than authorized product. The over delivery amount may or may not be noticeable to the end user. However, it may be advantageous to dispense an amount of product that is noticeable to the end user to facilitate communication to the establishment that the dispenser is operating in an unusual manner to aid in detecting that un-authorized product is being employed. For example, in a sheet product dispenser it is common to dispenser sheet product in amounts less than or equal to about 12 to 14 inches. The sheet length for “over delivery” can be 2 feet to 25 feet in length, specifically a length of 3 feet to 6 feet. In other embodiments, the dispenser can continue dispensing until an entire sheet product roll is depleted. The pile of sheet product on the floor can trigger a complaint to the facility operator. The facility operator can self diagnosis the problem by a warning label disposed on the dispenser 10 indicating that the dispenser may dispenser dispense more product if unauthorized product is employed. If the facility operator is unable to diagnosis the problem, the supplier may contact the owner or manufacturer of the dispenser, wherein the owner or manufacturer of the dispenser will immediately understand the problem to be un-authorized use of product. In other words, inquiries about over delivery of product can be used as a tool for policing and enforcing leases of proprietary systems.

In other embodiments, the dispenser can “under deliver” product to discourage dispensing of unauthorized product. The term “under delivery” refers to a pre-determined lesser amount of product to dispense compared to a normal dispense cycle if authorized product had been employed. For example, if the dispenser where programmed to dispenser “X” amount of authorized product, the dispenser can dispense half of X, a quarter of X, or a lesser amount if un-authorized product is employed. While under deliver may not destroy the cost-in-use proposition compared to over delivery, it does provide another means of detecting whether or not un-authorized product is being employed.

In other embodiments, the dispenser can dispenser product a “slower” speed compared to the speed at which product is dispensed during normal operation. For example, if the dispenser where programmed to dispenser “X” amount of authorized product per second, the dispenser can dispense half of X per second, a quarter of X per second, or a lesser amount per second, if un-authorized product is employed. Again, while a slower deliver speed may not destroy the cost-in-use proposition compared to over delivery, it does provide another means of detecting whether or not authorized product is being employed.

Without wanting to be bound by theory, it is believed that by not employing a lock-out scheme; goodwill with the end-user associated with the branded dispenser is maintained. In other words, in schemes where a dispenser is locked-out or disabled when an unauthorized sheet product is loaded into the dispenser, the end-user (i.e., the person using the dispenser) may form a negative impression of the branded dispenser. Whereas, by employing a design where the dispenser still dispenses product even when un-authorized product is employed, the goodwill associated with the brand is maintained, since the dispenser reliably dispensed paper. The un-authorized dispensing schedules discussed above discourage stuffing of the dispenser with unauthorized products, while trying to minimize any negative impressions that can tarnish the goodwill associated with a dispenser.

In other embodiments, to further limit negative impressions, the dispenser may provide feedback to the end user, the facility operator, the owner of the dispenser, and the like that unauthorized product has been employed. For example, in response to the loading of sheet product absent the reference indications 52, the dispenser 10 provides feedback to an external party, such as to a servicing attendant or sheet product user for example, that such unauthorized product has been loaded. As used herein, the term “feedback” shall be defined as an action taken by the dispenser 10 to indicate to the external party that such unauthorized product has been loaded into the dispenser. It will be appreciated that “feedback” is distinguished from inactivity (e.g., “locking out” or deactivation) of the dispenser 10. Indeed, the dispenser 10 is programmed to dispense sheet product, even if an unauthorized product is loaded into the dispenser 10; the dispenser 10 does not employ a “lock-out” scheme, if unidentified sheet products are employed in the dispenser.

In one embodiment, the microprocessor 46 may be responsive to loading of such material absent the reference indication 52 to indicate use of unauthorized product by flashing a light-emitting-diode (LED) 154 (FIG. 3) and/or set of an alarm. In other embodiments, the dispenser may also communicate that unauthorized product has been employed by communication to a cellphone, personal data assistant (PDA), a pager, telephone, email, and the like. For example, the dispenser 10 may optionally comprise a wireless modem or other wireless networking components disposed within the housing such that those providing the dispenser to end users can wirelessly monitor status information about the dispenser.

An embodiment of the invention may be embodied in the form of processor-implemented processes and apparatuses for practicing those processes. Embodiments of the present invention may also be embodied in the form of a processor program product having program code containing instructions embodied in tangible media, such as floppy diskettes, CD-ROMs, hard drives, USB (universal serial bus) drives, processor memory, or any other processor readable storage medium, wherein, when the program code is loaded into and executed by a processor, the processor is responsive to the executable instructions and becomes an apparatus for practicing the invention. Embodiments of the invention also may be embodied in the form of instructions, or program code, for example, whether stored in a storage medium, loaded into and/or executed by a processor, or transmitted over some transmission medium, such as over electrical wiring or cabling, through fiber optics, or via electromagnetic radiation, wherein when the instructions or program code are loaded into and executed by a processor, the processor becomes an apparatus for practicing the invention. When implemented on a general-purpose microprocessor, the instructions or program code segments configure the microprocessor to create specific logic circuits. A technical effect of the executable instructions is to dispense and measure a length of sheet product from a sheet dispenser.

As disclosed, some embodiments of the invention may include some of the following advantages: an ability to identify sheet product loaded within a dispenser; and an ability to provide feedback to an external party that unidentified sheet product has been loaded within a dispenser. A particularly useful advantage is the ability of the dispenser to dispense product per an unauthorized product schedule, when an unauthorized sheet product is employed in the dispenser. Customers are often tempted to use an inferior quality sheet product dispenser in a propriety dispensing system to save money. This practice, however, can destroy the reputation of the manufacturer of the proprietary dispensing system, since the product is of often of inferior quality to the product used in the proprietary system. Further, attempts to discourage this practice by locking-out (e.g. disabling) the dispenser can also tarnish the reputation and goodwill associated with the brand of the proprietary system. By dispensing product per an unauthorized product schedule, “stuffing” of the dispenser is discouraged.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A method of dispensing product, the method comprising:
determining by a processor if product loaded into a dispenser is authorized for use in the dispenser by identifying a reference indication associated with the product;
in response to determination that the product is authorized, dispense a first amount of product; and
in response to determination that the product is unauthorized, dispense a second amount of product, wherein the second amount of product is different than the first amount.

2. The method of claim 1, wherein in the second amount is greater than the first amount.

3. The method of claim 1, wherein the second amount is less than the first amount.

4. The method of claim 1, wherein the product is a sheet product.

5. The method of claim 4, wherein the sheet product is a roll of sheet product having a core, the reference indication being disposed on the core of the roll of sheet product.

6. The method of claim 1, wherein the reference indication comprises a plurality of tick marks.

7. The method of claim 1, wherein the reference indications comprise a phosphorescent ink.

8. A method of dispensing product, the method comprising:
determining by a processor if product loaded into a dispenser is authorized for use in the dispenser by identifying a reference indication associated with the product;
in response to determination that the product is authorized, dispense the product at a first speed; and
in response to determination that the product is unauthorized dispense the product at a second speed, wherein the second speed is different than the first speed.

9. The method of claim 8, wherein the second speed is less than the first speed.

10. The method of claim 8, wherein the product is a sheet product.

11. The method of claim 10, wherein the sheet product is a roll of sheet product having a core, the reference indication being disposed on the core of the roll of sheet product.

12. The method of claim 8, wherein the reference indication comprises a plurality of tick marks.

13. The method of claim 8, wherein the reference indications comprise a phosphorescent ink.

14. A sheet product, comprising:
a core; and
a sheet product web wound about the core, wherein the core comprises an overt indication that is visible to the human eye and/or a covert indication that is not visible to the human eye.

15. The sheet product of claim 14, wherein the covert indication comprises a phosphorescent ink.

16. A sheet product dispenser for dispensing sheet product from a roll, the sheet product dispenser comprising:
a processor responsive to executable instructions;
a support for rotatably supporting the roll;
a sensor in signal communication with the processor and responsive to rotation of the roll to detect a reference indication on a core of the roll, wherein the reference indication being associated with authorized use of the sheet product in the dispenser; and
a feed mechanism comprising a drive motor responsive to the processor for advancing the sheet product out of the sheet product dispenser;
wherein the processor, upon execution of the instructions, implements a method, the method comprising:
determining if the roll loaded into the sheet dispenser comprises the reference indication;
in response to determination that the sheet product has the reference indication dispense a first length of sheet product; and
in response to determination that the sheet product is absent the reference indication dispense a second length of sheet product, wherein the second length of sheet product is greater than the first length.

17. The sheet product dispenser of claim 16, wherein the second length is greater than the first length.

18. The sheet product dispenser of claim 16, wherein the second length is less than the first length.

19. The sheet product dispenser of claim 16, wherein the reference indications comprise a phosphorescent ink.

20. A sheet product dispenser for dispensing sheet product from a roll, the sheet product dispenser comprising:
a processor responsive to executable instructions;
a support for rotatably supporting the roll;
a sensor in signal communication with the processor and responsive to rotation of the roll to detect a reference indication on a core of the roll, wherein the reference indication being associated with authorized use of the sheet product in the dispenser; and
a feed mechanism comprising a drive motor responsive to the processor for advancing the sheet product out of the sheet product dispenser;
wherein the processor, upon execution of the instructions, implements a method, the method comprising:
determining if the roll loaded into the sheet dispenser comprises the reference indication;
in response to determination that the sheet product has the reference indication dispense sheet product at a first speed; and
in response to determination that the sheet product is absent the reference indication dispense sheet product at a second speed, wherein the second speed is different than the first speed.

21. The sheet product dispenser of claim 20, wherein the second speed is less than the first speed.
